(19) United States
(12) Patent Application Publication
(10) Pub. No.: US 2011/0132205 A1
(43) Pub. Date: Jun. 9, 2011

(54) COOKING GRID ASSEMBLY

(76) Inventor: James D. Brown, Castalia, OH (US)

(21) Appl. No.: 12/961,132

(22) Filed: Dec. 6, 2010

Related U.S. Application Data
(63) Continuation-in-part of application No. 11/430,115, filed on May 8, 2006, now Pat. No. 7,856,970.

(51) Int. Cl. A47J 37/07

(52) U.S. Cl. 99/450

(57) ABSTRACT

A cooking grid assembly includes a frame having first and second frame portions. The first and second frame portions each have one of a plurality of notches and a plurality of holes formed therein. A plurality of rods have first and second ends, such that the first end of each rod is disposed in one of the notches and holes of the first frame portion. The second end of each rod is disposed in one of the notches and holes of the second frame portion. A locking bar is removably attached to one of the first and second frame portions. The locking bar is movable between a closed position wherein the rods are retained in the one of the notches and holes, and an open position wherein the rods may be inserted and removed from the one of the notches and holes. An extension member is provided that is fixed to and outwardly movable relative to the frame to provide support to the frame. The extension member is movable between a storage position, an extended position, and a plurality of positions intermediate of the storage position and the extended position.

### CROSS-REFERENCE TO RELATED APPLICATIONS

This application is a Continuation-In-Part of U.S. patent application Ser. No. 11/430,115, filed May 8, 2006, the disclosures of which are incorporated by reference.

### BACKGROUND

Various embodiments of a barbecue cooking grid assembly are described herein. In particular, the embodiments described herein relate to an improved cooking grid assembly that is easy to assemble, disassemble, clean, and cook upon.

### SUMMARY

The present application describes various embodiments of a cooking grid assembly. Various aspects of the cooking grid assembly will become apparent to those skilled in the art from the following detailed description, when read in light of the accompanying drawings.

### BRIEF DESCRIPTION OF THE DRAWINGS

FIG. 1 is an exploded perspective view of a first embodiment of a cooking grid assembly.

FIG. 2 is a perspective view of the cooking grid assembly illustrated in FIG. 1, showing the cooking grid assembly assembled and in the latched position.

FIG. 3 is a perspective view of a portion of a second embodiment of a cooking grid assembly, showing an alternate embodiment of a latching mechanism.

FIG. 4 is a perspective view of a portion of a third embodiment of a cooking grid assembly, showing an alternate embodiment of a latching mechanism.

FIG. 4A is an enlarged elevational view of the latching mechanism illustrated in FIG. 4.

FIG. 5 is a schematic top plan view of a fourth embodiment of a cooking grid assembly.

FIG. 6 is an exploded perspective view of a fifth embodiment of a cooking grid assembly.

FIG. 7 is a perspective view of the cooking grid assembly illustrated in FIG. 6, showing the cooking grid assembly assembled and in the latched position.

FIG. 8 is an exploded perspective view of a sixth embodiment of a cooking grid assembly.

FIG. 9 is a perspective view of the cooking grid assembly illustrated in FIG. 8, showing the cooking grid assembly assembled and in the latched position.

FIG. 10 is an exploded perspective view of a seventh embodiment of a cooking grid assembly.

FIG. 11 is a partial exploded perspective view of various alternate embodiments of cooking rods and a cooperating frame with v-shaped notches.

FIG. 12 is a partial perspective view of an eighth embodiment of a cooking grid assembly having an alternate embodiment of a latching mechanism.

FIG. 13 is a partial sectional view of the latching mechanism shown in FIG. 12.

FIG. 14 is a partial perspective view of another alternate embodiment of a latching mechanism, which includes a floating nut plate and a captive screw.

### DETAILED DESCRIPTION

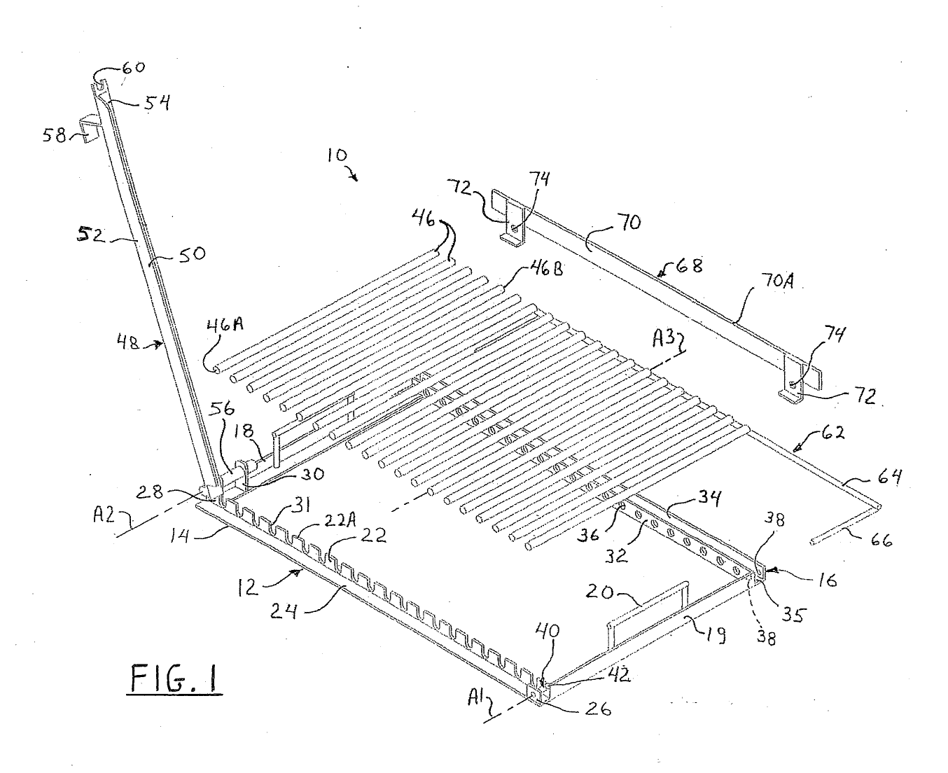

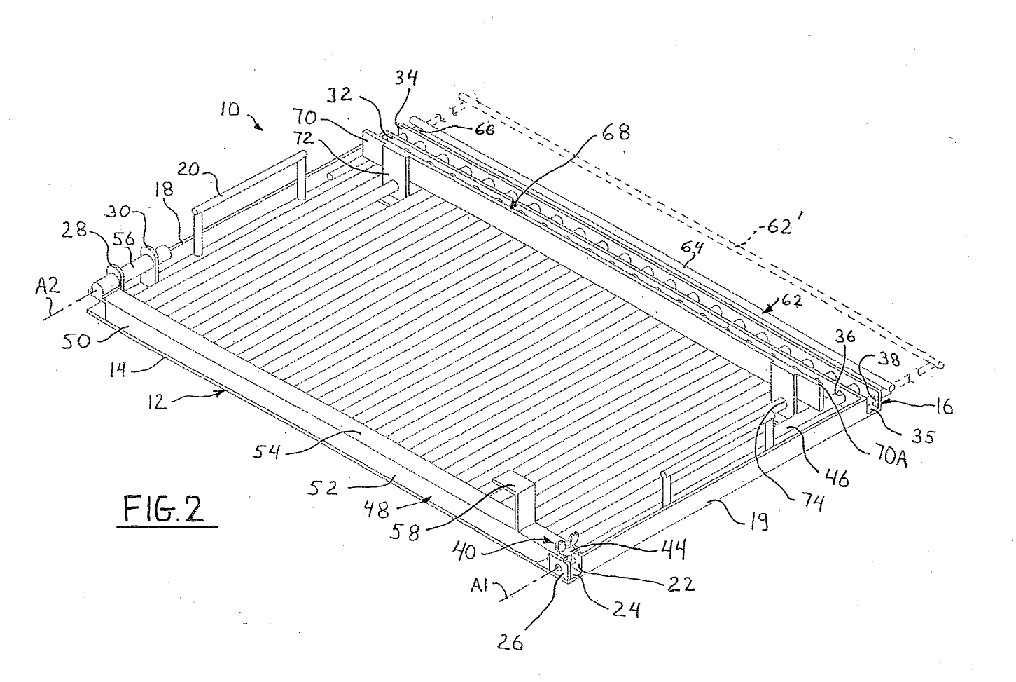

Referring now to FIGS. 1 and 2, there is illustrated a first embodiment of a cooking grid assembly, indicated generally at 10. In the illustrated embodiment, the cooking grid assembly 10 includes a frame 12. The frame 12 may include a first, or user facing, frame portion 14, a second frame portion 16, and transverse side members 18 and 19. If desired, the side members 18 and 19 may include a carrying handle 20 extending upwardly or outwardly therefrom. It will be understood that the transverse side members 18 and 19, or a portion thereof, may be formed integrally with the first frame portion 14 and/or the second frame portion 16. The frame 12 has a length and a width which cooperate to define a first area of the cooking grid assembly 10.

In the illustrated embodiment, the first frame portion 14 has a substantially L-shaped transverse section and includes an upwardly extending (as viewed in FIG. 1) portion 22 and an outwardly extending portion 24. In the illustrated embodiment, a first tab 26 and a second tab 28 extend upwardly from the opposite ends of the outwardly extending portion 24. A third tab 30 may extend upwardly from the transverse side member 18.

Notches 31 may be formed in an upwardly facing edge 22A of the upwardly extending portion 22. In the illustrated embodiment, the notches 31 are substantially U-shaped and are linearly disposed and axially parallel at regular intervals. Alternatively, the notches 31 may have any other desired shape, such as for example, a rectangular or a V-shape. It will be understood that as used herein, notches may be any opening in the upwardly facing edge 22A large enough to receive and support a rod 46, as will be described in detail below. For example, a plurality of bosses (not shown) extending outwardly from the edge 22A may define notches 31 in the spaces between adjacent such bosses.

In the illustrated embodiment, the second frame portion 16 has a substantially U-shaped transverse section, and includes an upwardly extending (as viewed in FIG. 1) first wall portion 32, an upwardly extending second wall portion 34, and a bottom portion 35 substantially co-planar with the outwardly extending portion 24.

Rod holes 36, the purpose of which is described in detail below, may be formed in the first wall portion 32. In the illustrated embodiment, the rod holes 36 are substantially circular and are linearly disposed and axially parallel at regular intervals. The rod holes 36 are further axially aligned with the notches 31. Alternatively, the rod holes 36 may have any other desired shape, such as for example, rectangular or other polygonal shapes. It will be understood that the first frame portion 14 may include holes 36, and the second frame portion 16 may include notches 31. Additionally, the first frame portion 14 and the second frame portion 16 may both include notches 31, or the first frame portion 14 and the second frame portion 16 may both include holes 36.

Extension mounting holes 38, the purpose of which is described in detail below, may be formed in the first and second wall portions 32 and 34. In the illustrated embodiment, two such mounting holes 38 are illustrated in each of the first and second wall portions 32 and 34. It will be understood that any desired number of mounting holes 38 may be formed in the first and second wall portions 32 and 34. The illustrated mounting holes 38 are substantially circular. Further, the mounting holes 38 of the first wall portion 32 are axially aligned with the mounting holes 38 of the second wall portion 34. Alternatively, the mounting holes 38 may have any other desired shape, such as for example, rectangular or other polygonal shapes. It will be understood that the second wall portion 34 and bottom portion 35 may not be required depending on the specifics of the installation. As will be described in detail below, the second wall portion 34 may be used to position the cooking rods 46 axially. Accordingly, the frame 12 may be formed without such wall and bottom portions 34 and 35.

The embodiment of the cooking grid assembly 10 illustrated in FIGS. 1 and 2 includes a latching mechanism 40. The illustrated latching mechanism 40 includes an externally threaded first latch member 42 that is mounted between the first frame portion 14 and the first tab 26 to rotate about a first pivot axis A1. The illustrated latching mechanism 40 further includes an internally threaded fastener 44, as shown in FIG. 2. Any desired threaded fastener, such as a hex nut or a wing nut may be provided.

In the illustrated embodiment, a locking bar 48 is pivotally attached to the first frame portion 14 by a pivot pin 56 to rotate about a second pivot axis A2. The illustrated locking bar 48 has an elongate body 50 having a substantially L-shaped transverse section and includes a downwardly extending (as viewed in FIG. 2) portion 52, and an inwardly extending portion 54. In the illustrated embodiment, the pivot pin 56 extends inwardly from one end of the body 50 and a handle 58 extends outwardly from an opposite end of the body 50. A latching notch 60 may be formed in the inwardly extending portion 54. In the illustrated embodiment, the notch 60 is substantially U-shaped. Alternatively, the notch 60 may have any other desired shape, such as for example, rectangular or a V-shape. The locking bar 48 may be formed without the downwardly extending portion 52 in embodiments of the cooking grid assembly 10 where such a locking bar 48 is not required to provide axial positioning of the cooking rods 46.

The illustrated cooking grid assembly 10 further includes a plurality of cooking rods 46 having a first end 46A, a second end 46B, and defining a rod axis A3. The installation and function of the cooking rods 46 will be discussed in detail below.

In the embodiment illustrated in FIGS. 1 and 2, an extension member 62 is outwardly movably mounted to the second frame portion 16 of the frame 12. The illustrated extension member 62 includes an elongate body 64, and a pair of inwardly extending legs 66, although any desired number of legs 66 may be provided. The illustrated body 64 and legs 66 are substantially cylindrical in shape. Alternatively, the body 64 and legs 66 may have any other desired shape, such as for example, having a rectangular or other polygonal-shaped transverse section.

As best shown in FIG. 2, the legs 66 of the extension member 62 are slidably mounted within the extension mounting holes 38 in the first and second wall portions 32 and 34. The extension member 62 is thereby movable between a fully retracted or storage position, as shown in FIG. 2, and an extended position, as shown by the phantom line 62′ in FIG. 2. It will be understood that the extension member 62 may be moved to a plurality of positions intermediate the storage position and the extended position. It will be further understood that the frame 12 and the extension member 62, when in the extended position or one of the intermediate positions, have a combined width and length that cooperate to define a second area of the cooking grid assembly 10, such that the second area is larger than the first area defined by the frame 12 alone.

In the embodiment illustrated in FIGS. 1 and 2, a “hamburger catcher” or food flange 68 is movably mounted on the cooking grid assembly 10. The illustrated food flange 68 includes an elongate body 70 having an upwardly facing edge 70A and a pair of downwardly extending (as viewed in FIG. 2) mounting tabs 72, although any desired number of tabs 72 may be provided. Each of the tabs 72 has a mounting hole 74 formed therein. The illustrated body 70 and tabs 72 are substantially rectangular in shape. Alternatively, the body 70 and tabs 72 may have any other desired shape. For example, the body 70 may have indicia formed therein and the upwardly facing edge 70A may have a serpentine, irregular, or other non-linear shape, or may define a decorative design. The food flange 68 is provided to prevent a food item, such as a hamburger patty, from being inadvertently pushed or otherwise moved off of the cooking rods 46 by a user of the cooking grid assembly 10.

As best shown in FIG. 2, the tabs 72 of the food flange 68 are slidably mounted on respective ones of the cooking rods 46, such that the food flange 68 is slidably mounted and moveable between the first frame portion 14 and the second frame portion 16.

The illustrated cooking grid assembly 10 and its component parts may be fabricated or otherwise formed from a suitable material, such as for example, steel, aluminum, alloys thereof, or other metals or alloy material. Ceramics are another example of suitable materials. Additionally, various coatings may be used to, for example, improve the stain resistance, corrosion resistance, or food release properties of the materials. Examples of such coatings include porcelain, Teflon®, and other non-stick coatings.

The first ends 46A of the cooking rods 46 are prevented from moving transversely by the cooperation of the inwardly extending portion 54 of the locking bar 48 and the first frame portion 14 defining the notches 31. The second ends 46B of the rods are prevented from moving transversely by the surrounding first wall portion 32 of the second frame portion 16.

The cooking rods 46 are positioned axially at the front by the abutting axially extending portion 52 of the locking bar 48, so as to prevent the first ends 46A of the cooking rods 46 from sliding toward the front (normally closer to the user) and the second ends 46B from becoming disengaged from the rod holes 36 of the second frame portion 16. Similarly, the second wall portion 34 of the second frame portion 16 abuts the second ends 46B of the cooking rods 46, positioning the cooking rods 46 and preventing each of the cooking rods 46 from sliding rearwardly (away from the usual position of the user) and preventing the first ends 46A of the cooking rods 46 from thus becoming disengaged from the associated notch 31 of the first frame portion 14.

It will be appreciated that in some embodiments of the cooking grid assembly 10, the cooking grid assembly 10 will be installed in a barbeque grill enclosure (fire box) having four walls extending slightly above the height of the cooking grid assembly 10. In such an installed use, with the cooking grid assembly 10 disposed in (i.e. placed into) the firebox, the walls of the firebox may so closely abut the periphery of the cooking grid assembly 10 that either or both of the second wall portion 34 of the second frame portion 16 and the downwardly extending portion 52 of the locking bar 48 may be omitted. In such embodiments, the walls of the firebox can act to axially position the rods of the cooking grid assembly 10.

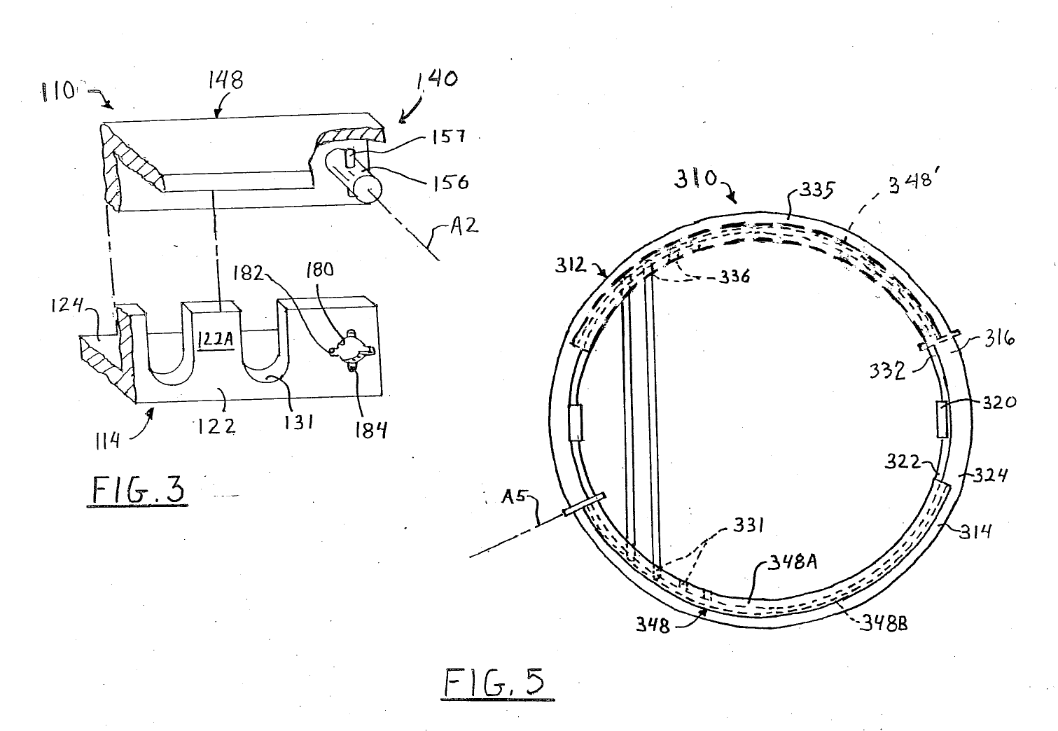

Referring now to FIG. 3, and using reference numbers ending with like last two digits to indicate corresponding parts, there is illustrated a perspective view of a portion of a second embodiment of the cooking grid assembly, indicated generally at 110. As shown therein, the cooking grid assembly 110 includes a first frame portion 114, a locking bar 148, and a latching mechanism, indicated generally at 140. The illustrated first frame portion includes an upwardly extending (as viewed in FIG. 3) portion 122 and an outwardly extending portion 124. Notches 131 may be formed in the upwardly extending portion 122. In the illustrated embodiment, the notches 131 are substantially U-shaped and are linearly disposed and axially parallel at regular intervals. Alternatively, the notches 131 may have any other desired shape, such as for example, rectangular or a V-shape.

In the illustrated embodiment, a first feature of the latching mechanism 140 is a pivot pin receiving hole 180 that is formed in the upwardly extending portion 122. The hole 180 includes radially extending locking pin notches 182. If desired, radially extending detent grooves 184 may be formed on an inwardly facing surface 122A of the upwardly extending portion 122. In the embodiment illustrated in FIG. 3, the detent grooves 184 are shown disposed at about 90 degrees relative to the locking pin notches 182. It will be understood, however, that the detent grooves 184 may be disposed at any desired angle relative to the locking pin notches 182.

A second feature of the illustrated latching mechanism 140 is a pivot pin 156 fixed to and extending inwardly from the downwardly extending portion 152 of the locking bar 148. At least one locking pin 157 extends radially outward of the pivot pin 156.

It will be understood that the locking bar 148 illustrated in FIG. 3 is pivotally attached to the first frame portion 114 to rotate about the pivot axis A2 (by use, for instance, of a handle, not shown) and is pivotal between a closed position and an open position. The locking bar 148 may further be mounted and/or removed from the first frame portion 114, such that no portion of the cooking grid assembly 110 is permanently deformed during the mounting and/or removal of the locking bar 148.

To install the locking bar 148 as illustrated in FIG. 3, the pivot pin 156 is inserted into the hole 180 such that locking pins 157 are aligned with the notches 182. The pin 156 may be pushed through the hole 180 until the locking pins 157 extend beyond the inwardly facing surface 122A of the upwardly extending portion 122. The locking bar 148 may then be pivoted about the pivot axis A2 between an open or unlatched position as shown in FIG. 1, and a closed or latched position as shown in FIG. 2. As best shown in FIG. 3, the locking pins 157 may be seated in the detent grooves 184, when the locking bar 148 is in the closed position.

To remove the locking bar 148 from the cooking grid assembly 110, the bar 148 may be rotated upwardly to the open position, such as shown in FIG. 1, until the locking pins 157 are again aligned with the notches 182. The pin 156 may be pulled outwardly from the first frame portion 114 to disengage pin 156 from the hole 180, thereby removing the locking bar 148 from the cooking grid assembly 110. It will be appreciated that the locking bar 148 may be inserted and removed from the first frame portion 114 such that no portion of the cooking grid assembly 110 is permanently deformed during the removal of the locking bar 148.

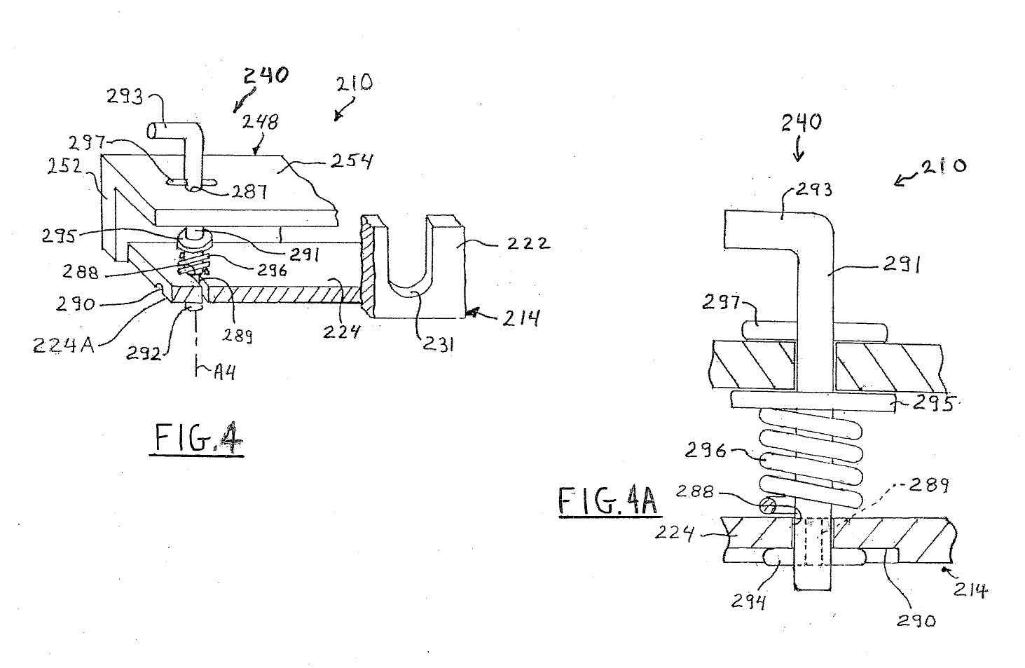

Referring now to FIGS. 4 and 4A, and using reference numbers ending with like last two digits to indicate corresponding parts, there is illustrated a perspective view of a portion of a third embodiment of the cooking grid assembly, indicated generally at 210. As shown therein, the cooking grid assembly 210 includes a first frame portion 214, a locking bar 248, and a latching mechanism, generally indicated at 240. The illustrated first frame portion 214 includes an upwardly extending (as viewed in FIG. 4) portion 222 and an outwardly extending portion 224. Notches 231 may be formed in the upwardly extending portion 222. In the illustrated embodiment, the notches 231 are substantially U-shaped and are linearly disposed and axially parallel at regular intervals to receive the cooking rods 246. Alternatively, the notches 231 may have any other desired shape, such as for example, rectangular or a V-shape.

The illustrated locking bar 248 includes a downwardly extending (as viewed in FIG. 4) portion 252, and an inwardly extending portion 254. In the illustrated embodiment, the latching mechanism 240 includes a first latch receiving hole 287 that is formed in the inwardly extending portion 254 of the locking bar 248.

The latching mechanism 240 also includes a second latch receiving hole 288 that is formed in the outwardly extending portion 224 of the first frame portion 214. The hole 288 includes radially extending locking pin notches 289. Radially extending detent grooves 290 may be formed on a downwardly facing surface 224A of the outwardly extending portion 224. In the embodiment illustrated in FIG. 4, the detent groove 290 is shown disposed at about 90 degrees relative to the locking pin notches 289. It will be understood, however, that the detent groove(s) 290 may be disposed at any desired angle relative to the locking pin notches 289.

The latching mechanism 240 illustrated in FIGS. 4 and 4A may further include an elongate body 291 having a first end 292, a second end defining a handle portion 293, and a pivot axis A4 about which the body 291 may pivot, as described below. At least one locking pin 294 and a spring flange 295 may extend radially outward of the body 291. Alternatively, the spring flange could be other than as illustrated. For example, the spring flange 295 could comprise a washer supported by a pin and disposed between the retaining pin 297 and a spring 296. Alternatively, the spring flange may be any structure suitable for preventing upward axial movement (as viewed in FIG. 4A) of the spring 296.

The spring 296 is disposed between the locking pin 294 and the spring flange 295. At least one retaining pin 297 extends radially outward of the body 291 between the spring flange 295 and the handle portion 293. The retaining pin 295 may suitably be a pin, such as a roll pin inserted through a bore (not shown) formed through the body 291 after the body 291 is positioned in the first latch receiving hole 287 with the spring flange 295 abutting the inwardly extending portion 254 of the locking bar 248. The illustrated body 291 is substantially cylindrical in shape. Alternatively, the body 291 may have any other desired shape, such as for example, having a rectangular or other polygonal-shaped transverse section, provided the body 291 can rotate within the latch receiving holes 287 and 288 about the pivot axis A4.

As best shown in FIG. 4, the body 291 is slidably and pivotally mounted within the first latch receiving hole 287 about the pivot axis A4, such that a portion of the locking bar 248 is disposed between the spring flange 295 and the retaining pin 297. When the locking bar 248 is moved to a locked position, the latching mechanism 240 may be positioned in a latched position in which, as shown in FIG. 4, the body 291 is disposed in the second latch receiving hole 288 of the first frame portion 214 such that the spring 296 urges the locking pin 294 into the detent groove 290. To unlatch the locking bar 248, the body 291 is rotated about the pivot axis A4 until the latching pin 294 aligns with the locking pin notch 289. The body 291 is then moved upwardly (as viewed in FIG. 4A) from the first frame portion 214 to disengage the body 291 from the hole 288, thereby unlatching the locking bar 248 from the first frame portion 214. The locking bar 248 can then be rotated to an unlocked position, freeing the associated cooking rods from the frame 212 of the cooking grid assembly 210.

Returning to the embodiment illustrated in FIGS. 1 and 2, to assemble the cooking grid assembly 10, the second ends 46B of the cooking rods 46 are inserted into the holes 36 of the second frame portion 16. If desired, the food flange 68 may then be slidably mounted on at least one rod (in FIG. 2, the food flange 68 is shown mounted on two rods 46, however, the food flange 68 may be mounted on any desired number of rods 46, suitably configured, prior to installation of the rods into the holes 36). The first ends 46A of the cooking rods 46 are then disposed in the notches 31 of the first frame portion 14. The locking bar 48 may then be pivotally attached to the first frame member 14 and moved to the closed position. The locking bar 48 may then be latched by the latch 40. Alternatively, alternate structures may be utilized to secure the cooking rods; for example, the locking bar may be latched to the first support member by a latching mechanism similar to any of those described herein, including the latching mechanisms 140 and 240 described above. The cooking grid assembly 10 is thereby easy to assemble, disassemble, clean, and cook upon.

If it is desired to install the cooking grid assembly 10 in a grill box having a distance between grate support structures (not shown) larger than the depth of the frame 12, the extension member 62 may be moved from a retracted position adjacent the frame 12 (illustrated in solid lines in FIG. 2) to the extended position 62′ (illustrated in dashed lines in FIG. 2), or to one of the intermediate positions therebetween, thereby enlarging the area of the cooking grid assembly 10, i.e., allowing the cooking grid assembly 10 to be installed in a space of larger area than the cooking area defined by the cooking rods 46.

Referring now to FIG. 5, there is illustrated a schematic top plan view of a portion of a fourth embodiment of the cooking grid assembly, indicated generally at 310. In the illustrated embodiment, the cooking grid assembly 310 includes a frame 312. The frame 312 may include a first frame portion 314 connected to a second frame portion 316. It will be understood that the first frame portion 314 and the second frame portion 316 may be integrally formed. If desired, the frame portions 314 and 316 may include a pair of carrying handles, such as the substantially D-shaped handles 320 shown in FIGS. 1 and 2, extending upwardly or outwardly therefrom.

In the illustrated embodiment, the first frame portion 314 has a substantially L-shaped transverse section and includes an upwardly extending (toward the viewer as viewed in FIG. 5) portion 322 and a radially outwardly extending portion 324.

Notches 331 (for clarity, only a portion of the notches 331 are shown in FIG. 5) may be formed in an upwardly facing edge of the upwardly extending portion 322. The notches 331 may have any desired shape, such as substantially U-shaped, and may be arrayed along the upwardly extending portion 322 such that the notches 331 are axially parallel and disposed at regular intervals. Alternatively, the notches 331 may have any other desired shape, such as for example, a rectangular or a V-shape.

In the illustrated embodiment, the second frame portion 316 has a substantially L-shaped transverse section and includes an upwardly extending (toward the viewer as viewed in FIG. 5) portion 332 and an outwardly extending portion 335.

Rod holes 336 (for clarity, only a portion of the holes 336 are shown in FIG. 5) may be formed in the upwardly extending portion 332. The rod holes 336 may be substantially circular and may be arrayed along the upwardly extending portion 332 such that the holes 336 are axially parallel and disposed at regular intervals. The rod holes 336 are further axially aligned with the notches 331. Alternatively, the rod holes 336 may have any other desired shape, such as for example, rectangular or other polygonal shapes. It will be understood that the first frame portion 314 may include holes 336, and the second frame portion 316 may include notches 331.

In the illustrated embodiment, a locking bar 348 is pivotally attached to the first frame portion 314 about a fifth pivot axis A5. The illustrated locking bar 348 has a substantially arcuate shape corresponding to the shape of the first frame portion 314 and has a substantially L-shaped transverse section. The locking bar 348 includes a horizontally extending portion 348A overlaying the first frame portion 314, and a downwardly extending portion 348B on the outer periphery of the horizontally extending portion 348A that axially positions rods 346 (discussed below) disposed in the holes 336 and notches 331. It will be understood that a second locking bar 348′ having a shape corresponding to the shape of the second frame portion 316 may be pivotally attached to the second frame portion 316, as illustrated by dashed lines in FIG. 5.

The locking bar 348 may include the latching mechanism 240 illustrated in FIGS. 4 and 4A. The locking bar 348 may further include a pivot pin such as the pivot pin 157. The locking bar 348 may therefore be mounted and/or removed from the first frame portion 314, such that no portion of the cooking grid assembly 310 is permanently deformed during the mounting and/or removal of the locking bar 148. The illustrated cooking grid assembly 310 further includes a plurality of cooking rods 346 (only two such rods 346 are shown in FIG. 5). If desired, the cooking grid assembly 310 may also include a substantially arcuate food flange (not shown), similar to the food flange 68.

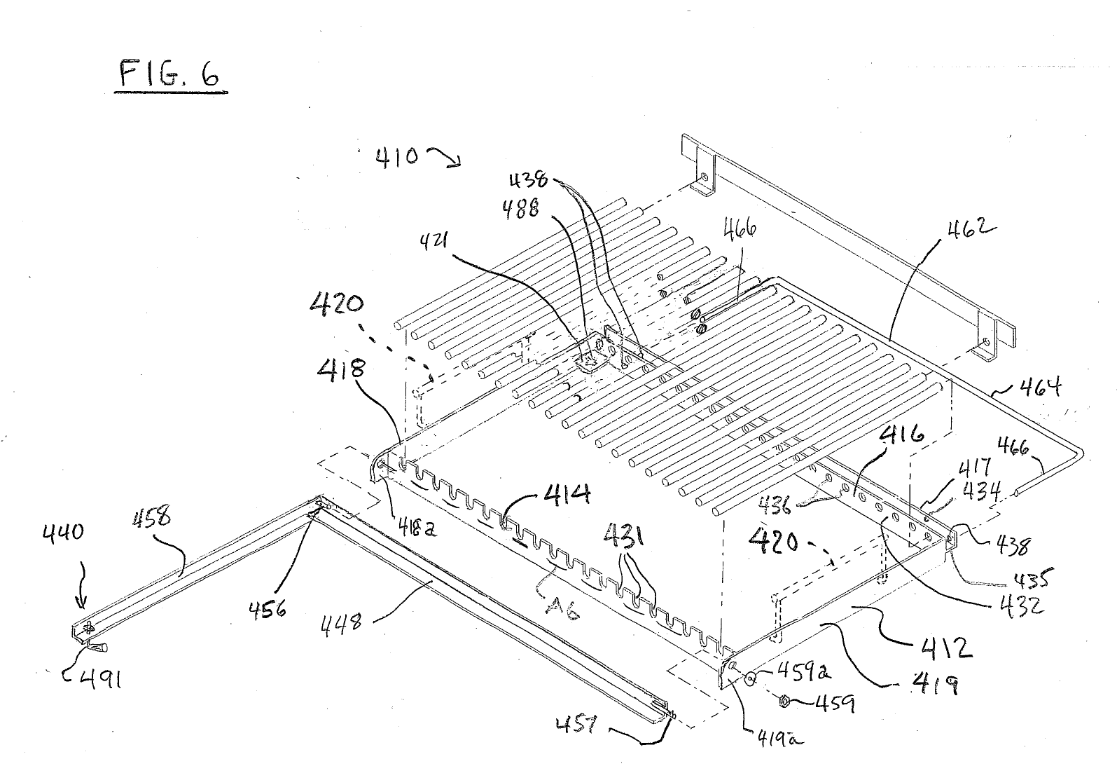

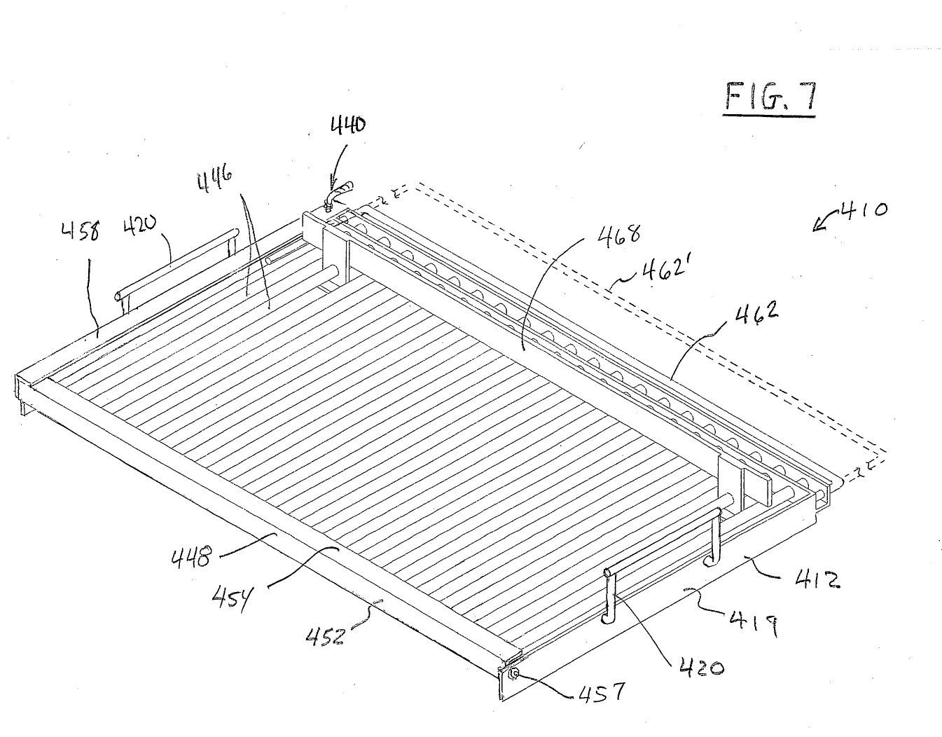

FIG. 6 is an exploded perspective view of a fifth embodiment of a cooking grid assembly, indicated generally at 410, and FIG. 7 is a perspective view of the assembled cooking grid assembly 410. In the illustrated embodiment, the cooking grid assembly 410 may include a frame 412. The frame 412 may include a first, or user facing, frame portion 414, a second frame portion 416, and transverse side members 418 and 419. It will be understood that the transverse side members 418 and 419, or a portion thereof, may be formed integrally with the first frame portion 414 and/or the second frame portion 416. The frame 412 has a length and a width, which cooperate to define a first area of the cooking grid assembly 410.

If desired, the side members 418 and 419 may each include a carrying handle 420 extending upwardly or outwardly therefrom (shown in dashed lines in FIG. 6, and solid lines in FIG. 7).

In the illustrated embodiment, the first frame portion 414, and the side members 418 and 419 are shown having substantially rectangular transverse sections. It will be understood, however, that various parts of the frame 412 may suitably be provided with transverse cross-sections other than that illustrated, such as the L-shaped transverse section of the first frame portion 14 of FIG. 1 to provide additional rigidity or other desired characteristics.

Notches 431 may be formed in an upwardly facing edge of the first frame portion 414. The notches 431 may have any desired shape, such as the substantially U-shaped notch illustrated, and may be arrayed along the upwardly facing edge of the first frame portion 414 such that the notches 431 are disposed at regular intervals. Alternatively, the notches 431 may have any other desired shape, such as, for example, a rectangular or a V-shape.

In the illustrated embodiment, the second frame portion 416 may have a substantially rectangular transverse section forming a first wall portion 432. The second frame portion 416 may be provided with a substantially L-shaped flange 417 that may include an upwardly extending second wall portion 434, and a bottom portion 435.

Rod holes 436 (for clarity, only a portion of the holes 436 are shown in FIG. 5) may be formed in the first wall portion 432. The rod holes 436 are illustrated as being substantially circular. The holes 436 may be arrayed along the first wall portion 432 such that the holes 436 are axially parallel and disposed at regular intervals. The rod holes 436 are preferably axially aligned with the notches 431. Alternatively, the rod holes 436 may have any other desired shape, such as for example, vertically extended ovals, or square, rectangular, hexagonal, octagonal, or other polygonal shapes, or combinations thereof.

The two side members 418 and 419 may extend beyond the first frame portion 414 to form, respectively, tabs 418a and 419a. Each of the tabs 418a and 419a has a respective aperture therethrough, the apertures in the tabs 418a and 419a cooperating to define a pivot axis A6 generally parallel to the first frame portion 414.

A tab 421 may be fixed to, and extend inwardly from, the frame 412 at the corner formed by the second frame portion 416, and the side member 418. The tab 421 may suitably define a plane co-planar with, or parallel to, a plane defined by the bottom portion 435 of the flange 417 on the second frame portion 416.

The illustrated cooking grid assembly 410 further includes a plurality of cooking rods 446. The cooking rods 446 may have a circular transverse cross-section, or any other suitable transverse cross-section, including, for example, triangular, square, rectangular, hexagonal, octagonal, or other polygonal shapes The installation and function of the cooking rods 446 will be discussed in detail below.

A locking bar 448 may be pivotally attached to the first frame portion 414 by a pair of pivot pins 456 and 457 to rotate about the pivot axis A6. The illustrated locking bar 448 has an elongate body 450 having a substantially L-shaped transverse section and includes a downwardly extending (as viewed in FIG. 7) portion 452, and an inwardly extending portion 454 that overlays the first frame portion 414 when the locking bar 448 is in a locked position thereof, which locked position is shown in FIG. 7.

During assembly of the locking bar 448 to the frame 412, the pivot pins 456 and 457 may be aligned with and urged through respective ones of the apertures in the tabs 418a and 419a cooperating to define the pivot axis A6. If desired, one or both of the pivot pins 456 and 457 may be threaded at a free end thereof, so that a nut 459 may be threaded onto the threaded free end to capture the pivot pins in the apertures in the tabs 418a and 419a. Suitably, flat washers 459a may also be provided. Any suitable alternative capture devices to the nut 459 can be used, such as a cotter pin engaging a hole drilled through a respective pivot pin (not shown). Alternatively, no capture mechanism need be used to hold the pivot pins 456 and 457 in the apertures in the tabs 418a and 419a; a user may merely avoid urging the locking bar 448 leftward relative to the frame 412 (as viewed in FIGS. 6 and 7) while rotating the locking bar 448 between locked and unlocked positions. As will be explained below, a latching mechanism 440 may be provided, which, when latched, may assist in preventing the locking bar 448 from moving to the left during use of the cooking grid assembly 410, and thus prevent the pivot pins 456 and 457 from becoming disengaged from the apertures in the tabs 418a and 419a. The locking bar 448 may therefore be mounted and/or removed from the first frame portion 414, such that no portion of the cooking grid assembly 410 is permanently deformed during the mounting and/or removal of the locking bar 148. Alternatively, a permanent capture mechanism may be used, such as upsetting the ends of the pivot pins 456 and 457, or welding on an enlarged end, so that the ends are of larger diameter than the apertures in the tabs 418a and 419a (not shown).

A handle 458 may be fixed to the body 450 to facilitate rotating the locking bar 448 between the locked position shown in FIG. 7, and an unlocked position where the portion 454 does not closely overlay the first frame portion 414. The handle 458 may suitably be formed with an L-shaped transverse cross-section for rigidity.

A latching mechanism 440, such as one similar to the latching mechanism 240 described above, or other suitable latching mechanism, may be provided to selectively latch the locking bar 448 in the locked position. The illustrated latching mechanism 440 may include a first latch receiving hole that is formed in an inwardly extending portion of the locking bar 448.

The latching mechanism 440 may also include a second latch receiving hole 488 that is formed in the outwardly extending tab 421. The hole 488 may include radially extending locking pin notches similar to the notches 289 described above. Radially extending detent grooves (not shown, but which may be similar to the grooves 290) may be formed on a downwardly facing surface of the tab 421.

The latching mechanism 440 may also include a body 491, similar to the body 221, and which is provided with a handle portion similar to the handle portion 293, a locking pin similar to the locking pin 294, a spring flange similar to the spring flange 295, a spring similar to the spring 296, and a retaining pin similar to the retaining pin 297. The body 491 is slidably and pivotally mounted within the first latch receiving hole, such that a portion of the locking bar 448 is disposed between the spring flange and the retaining pin. When the locking bar 448 is moved to the locked position thereof, the latching mechanism 440 may be positioned in a latched position in which the body 491 is disposed in the second latch receiving hole 488 of the tab 421 such that the spring urges the locking pin into the detent groove. The latching mechanism 440 will then act to hold the locking bar 448 in the locked position, and additionally, may prevent movement of the locking bar 448 leftward (as seen in FIGS. 6 and 7) to assist in preventing the pivot pins 456 and 457 from becoming disengaged from respective ones of the apertures in the tabs 418a and 419a.

In the locked position, the inwardly extending portion 454 of the locking bar 448 will prevent upward movement of the cooking rods 446 out of the notches 431. Additionally, the downwardly extending portion 452 of the locking bar 448 will prevent axial movement of the cooking rods 446 away from the second frame portion 416. Thus, when the locking bar 448 is in the locked position, the first frame portion 414 and the locking bar 448 may cooperate to support the adjacent end of each of the cooking rods 446 against any movement except that generally toward the second frame portion 416. The second frame portion 416 and the flange 417, including the first wall portion 432 and the second wall portion 434 cooperate to support the adjacent end of each of the cooking rods 446 against any motion except generally toward the first frame portion 414. Thus together the first frame portion 414, the second frame portion 416, the locking bar 448 and the flange 417 capture the cooking rods 446 against any substantial movement relative to the frame 412. To unlatch the locking bar 448, the body 491 is rotated until the latching pin 494 aligns with the locking pin notches. The body 491 is then moved upwardly from the tab 421 to disengage body 491 from the hole 488, thereby unlatching the locking bar 448. The locking bar 448 can then be rotated to an unlocked position, allowing the associated ends of the cooking rods 446 to be moved upwardly (with reference to the position shown in FIGS. 6 and 7) out of the notches 431 in the first frame portion 414. This permits the other ends of the cooking rods 446 to be pulled generally axially (albeit at a slight angle to the captured position shown in FIG. 7) from the rod holes 436, freeing the associated cooking rods 446 from the frame 412 of the cooking grid assembly 410. Instead of individually removing the cooking rods from the notches 431, the cooking grid assembly 410 could, of course, be inverted from the position shown in FIGS. 6 and 7 when the locking bar 448 is in an unlocked position (and preferably removed by disengaging the pivot pins 456 and 457 from the apertures in the tabs 418a and 419a), permitting the ends of the cooking rods 446 to simultaneously fall free from the notches 431, slide out of the rod holes 436 and fall upon a surface below, such as into a cleaning sink.

An extension member 462 may be outwardly movably mounted to the second frame portion 416 of the frame 412. The illustrated extension member 462 includes an elongate body 464, and a pair of inwardly extending legs 466, although any desired number of legs 466 may be provided. The illustrated body 464 and legs 466 may be substantially cylindrical in shape. Alternatively, the body 464 and legs 466 may have any other desired shape, such as for example, having a rectangular or other polygonal-shaped transverse section. The legs 466 of the extension member 462 may be slidably mounted within extension mounting holes 438 in the first and second wall portions 432 and 434. Note that the extension mounting holes 438 closest to the side member 418 are defined in the second frame portion 416 just inwardly of the tab 421, so as to not interfere with the operation of the latching mechanism 440. The extension member 462 is movable between a fully retracted or storage position, as shown in FIG. 7, and an extended position, as shown by the phantom line 462′ in FIG. 7. It will be understood that the extension member 62 may be moved to a plurality of positions intermediate the storage position and the extended position. It will be further understood that the frame 412 and the extension member 462, when in the extended position or one of the intermediate positions, have a combined width and length that cooperate to define a second area of the cooking grid assembly 410, such that the second area is larger than the first area defined by the frame 412 alone. The extension member 462 will allow the cooking grid assembly 410 to be adapted to be supported upon a variety of structures (not shown) having different “front to back” depths between features (not shown) supporting the first frame portion 414 and features (not shown) supporting the second frame portion 416 via the extension member 462.

If desired, the cooking grid assembly 410 may also include a food flange 468, similar to the food flange 68. The food flange 468 may be especially useful in conjunction with the extension member 462 to prevent food from falling into the space between the second flange portion 416 and the body 464 of the extension member 416 when the extension member 416 is in an extended position thereof. However, it should be understood that either the extension member 462 or the food flange 468 might be used without the other. It should be also understood that the food flange 468 is useful simply from the standpoint of being an easily removed and cleaned surface which facilitates (for example) inserting a spatula (not shown) under food (not shown), such as burger patties, by preventing sliding movement of the food.

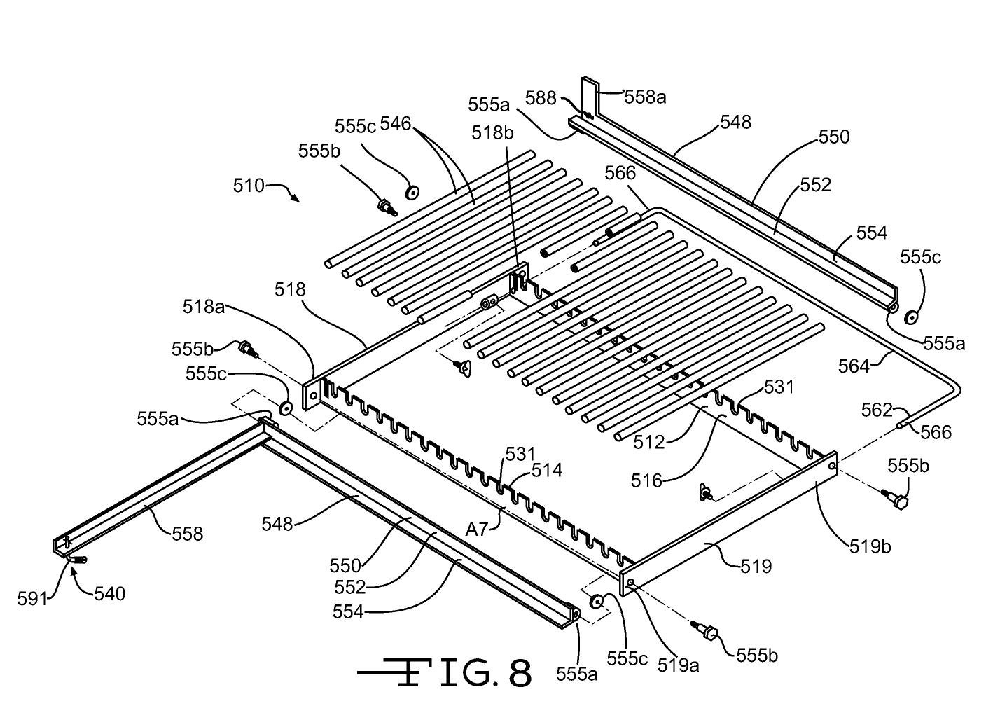

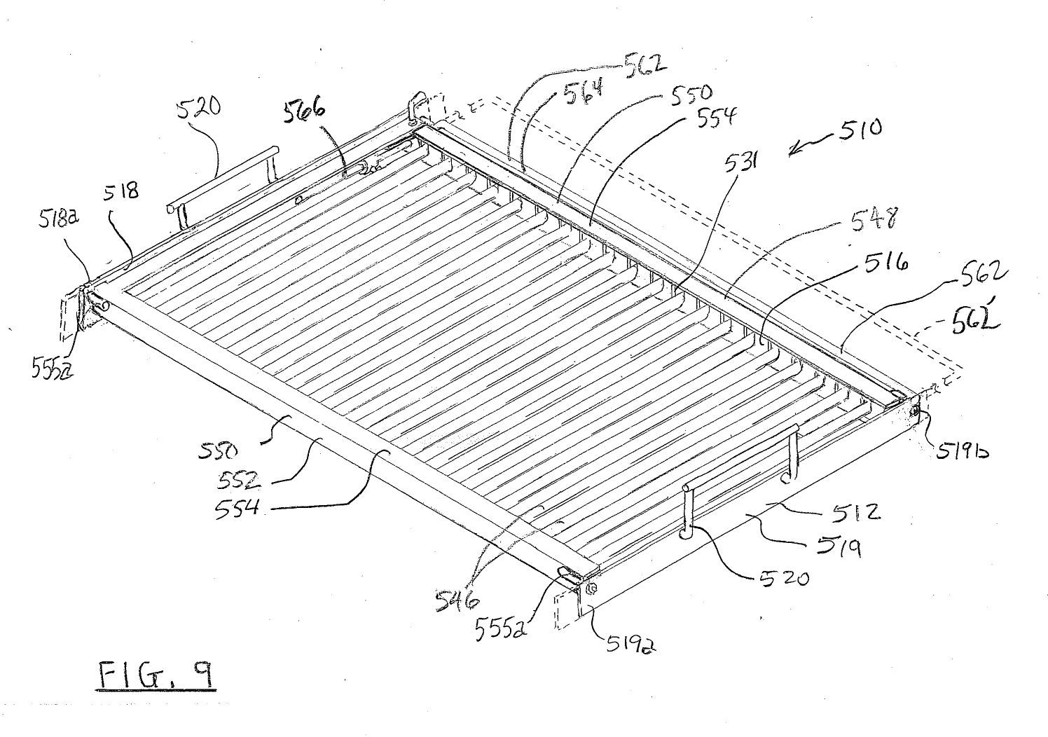

FIG. 8 is an exploded perspective view of a sixth embodiment of a cooking grid, indicated generally at 510, and FIG. 9 is a perspective view of the cooking grid assembly 510, showing the cooking grid assembly 510 assembled and in a locked and latched position thereof. In the illustrated embodiment, the cooking grid assembly 510 may include a frame 512. The frame 512 may include a first, or user facing, frame portion 514, a second frame portion 516, and first and second transverse side members 518 and 519. It will be understood that the transverse side members 518 and 519, or a portion thereof, may be formed integrally with the first frame portion 514 and/or the second frame portion 516. The frame 512 has a length and a width, which cooperate to define a first area of the cooking grid assembly 510.

If desired, the first and second transverse side members 518 and 519 may each include a carrying handle 520 extending upwardly or outwardly therefrom (shown in FIG. 9 only).

In the illustrated embodiment, the first frame portion 514, the second frame portion 516, and the side members 518 and 519 are shown having substantially rectangular transverse sections. It will be understood, however, that various parts of the frame 512 may suitably be provided with transverse cross-sections other than that illustrated, such as the L-shaped transverse section of the first frame portion 14 of FIG. 1 to provide additional rigidity or other desired characteristics.

Notches 531 may be formed in an upwardly facing edge of the first frame portion 514 and in an upwardly facing edge of the second frame portion 516. The notches 531 may have any desired shape, such as the substantially U-shaped notch illustrated, and may be arrayed along the upwardly facing edge of the first frame portion 514 and the second frame portion 516 such that the notches 531 are disposed at regular intervals. Alternatively, the notches 531 may have any other desired shape, such as, for example, a rectangular or a V-shape.

The two side members 518 and 519 may extend beyond the first frame portion 514 to form, respectively, tabs 518a and 519a. The two side members 518 and 519 may extend beyond the second frame portion 516 to form, respectively, tabs 518b and 519b. Each of the tabs 518a and 519a has a respective aperture therethrough, the apertures in the tabs 518a and 519a cooperating to define a pivot axis A7 extending therebetween generally parallel to the first frame portion 514. The apertures in the tabs 518b and 519b similarly cooperating to define a pivot axis (not shown) extending therebetween generally parallel to the second frame portion 516. As shown in FIG. 9, the tabs 518a and 519a may be suitably extended substantially beyond the respective apertures formed therein, and engage supporting structures (such as a flange on a grill firebox wall or an upper surface of a fire ring, not shown) to support the first frame portion 514. Similarly, the tabs 518b and 519b may be suitably extended substantially beyond the respective apertures formed therein, and engage supporting structures to support the second frame portion 516.

The illustrated cooking grid assembly 510 further includes a plurality of cooking rods 546. The cooking rods 546 may have a circular transverse cross-section, or any other suitable transverse cross-section, including, for example, triangular, square, rectangular, hexagonal, octagonal, or other polygonal shapes. The installation and function of the cooking rods 546 will be discussed in detail below.

A first locking bar 548 may be pivotally attached, as will be described, to the first frame portion 514 for rotation about the pivot axis A7. The illustrated first locking bar 548 has an elongate body 550 having a substantially L-shaped transverse section and includes a downwardly extending (as viewed in FIG. 9) portion 552, and an inwardly extending portion 554 that overlays the first frame portion 514 when the first locking bar 548 is in a locked position thereof, which locked position is shown in FIG. 9. Internally threaded fasteners 555a, such as nuts, may be fixed (by any suitable method, such as welding) at opposed ends of the body 550 such that the axes of the fasteners 555 are aligned with the pivot axis A7. Respective externally threaded fasteners 555b, such as bolts, may be inserted through the apertures in the tabs 518a and 519a to engage an associated one of the fasteners 555a, retaining the locking bar 558 for rotation about the pivot axis A7. Suitably, flat washers 555c may be captured on the externally threaded fasteners 555b between each end of the body 550 and the adjacent tab 518a, 519a, to reduce friction during rotation of the first locking bar 548. A handle 558 may be fixed to the body 550 to facilitate rotating the first locking bar 548 between the locked position shown in FIG. 9, and an unlocked position where the portion 554 does not closely overlay the first frame portion 514. The handle 558 may suitably be formed with an L-shaped or other shaped transverse cross-section for rigidity.

A second locking bar 548 may be pivotally attached, as will be described, to the second frame portion 516 for rotation about the pivot axis defined between the apertures of the tabs 518b and 519b. Like the first locking bar 548 mounted adjacent the first frame portion 514, the second locking bar 548 has an elongate body 550 having a substantially L-shaped transverse section and includes a downwardly extending (not seen in FIG. 9) portion 552, and an inwardly extending portion 554 that overlays the second frame portion 516 when the second locking bar 548 is in a locked position thereof, which locked position is shown in FIG. 9. Internally threaded fasteners 555a, such as nuts, may be fixed (by any suitable method, such as welding) at opposed ends of the body 550 such that the axes of the fasteners 555 are aligned with the associated pivot axis. Respective externally threaded fasteners 555b, such as bolts, may be inserted through the apertures in the tabs 518a and 519a to engage an associated one of the fasteners 555a, retaining the locking bar 558 for rotation about the pivot axis adjacent the second frame portion 516. Suitably, flat washers 555c may be captured on the externally threaded fasteners 555b between each end of the body 550 and the adjacent tab 518a, 519a, to reduce friction during rotation of the second locking bar 548. A handle 558a may be fixed to the body 550 to facilitate rotating the second locking bar 548 between the locked position shown in FIG. 9, and an unlocked position where the portion 554 does not closely overlay the first frame portion 514. Although shown as a flat member, the handle 558a may suitably be formed with an L-shaped or other shaped transverse cross-section for rigidity. In the illustrated embodiment, the handle 558a is not as long as the handle 558.

The handle 558 may be longer than the handle 558a, because, in the illustrated embodiment the handle 558 carries a latching mechanism 540, such as one similar to the latching mechanism 240 described above, or other suitable latching mechanism, at a free end thereof. The latching mechanism 540 may be provided to selectively latch the second locking bar 548 in the locked position.

The latching mechanism 540 may also include a latch receiving hole 588 that is formed in the second locking bar 548 at a location where the latch receiving hole 588 may be engaged by the portion of the latching mechanism 540 on the handle 558 of the first locking bar 548. The latch receiving hole 588 may include radially extending locking pin notches similar to the notches 289 described above. Radially extending detent grooves (not shown, but which may be similar to the grooves 290) may be formed on the body 550 of the second locking bar 548.

The latching mechanism 540 may also include a body 591, similar to the body 221, and which is provided with a handle portion similar to the handle portion 293, a locking pin similar to the locking pin 294, a spring flange similar to the spring flange 295, a spring similar to the spring 296, and a retaining pin similar to the retaining pin 297. The body 591 is slidably and pivotally mounted within a receiving hole formed in the handle 558, such that a portion of the second locking bar 548 is disposed between the spring flange and the retaining pin. When the first locking bar 548 and the second locking bar 548 are moved to the locked positions thereof, the latching mechanism 540 may be positioned in a latched position in which the body 591 is disposed in the latch receiving hole 588 of the tab 521 such that the spring urges the locking pin into the detent groove. The latching mechanism 540 may then act to hold the first locking bar 548 in the locked position thereof, and additionally, prevent rotation of the second locking bar 548 out of the locked position thereof.

In the locked position, the inwardly extending portions 554 of the first locking bar 548 and the second locking bar 548 will prevent upward movement of the cooking rods 546 out of the notches 531. Additionally, the downwardly extending portion 552 of the first locking bar 548 will prevent axial movement of the cooking rods 546 away from the downwardly extending portion 552 of the second locking bar 548. Similarly, the downwardly extending portion 552 of the second locking bar 548 will prevent axial movement of the cooking rods 546 away from the downwardly extending portion 552 of the first locking bar 548. Thus, when the locking bar 548 is in the locked position, the first frame portion 514 and the first locking bar 548 may cooperate to support the adjacent end of each of the cooking rods 546 against any movement except that generally toward the second frame portion 516. The second frame portion 516 and the second locking bar 548 cooperate to support the adjacent end of each of the cooking rods 546 against any motion except generally toward the first frame portion 514. Thus, the first frame portion 514, the second frame portion 516, the first locking bar 548, and the second locking bar 548 cooperate to capture the cooking rods 546 against any substantial movement relative to the frame 512. To unlatch the first locking bar 548 and the second locking bar 548, the body 591 is rotated until the latching pin 594 aligns with the locking pin notches. The body 591 is then moved upwardly from the second locking bar 548 to disengage body 591 from the hole 588, thereby unlatching the first locking bar 548. The first locking bar 548 can then be rotated to an unlocked position, allowing the associated ends of the cooking rods 546 to be moved upwardly (with reference to the position shown in FIGS. 8 and 9) out of the notches 531 in the first frame portion 514. Rotating the first locking bar 548 out of the locked position also frees the second locking bar 548 for rotation to an unlocked position thereof, allowing the associated ends of the cooking rods 546 to be moved upwardly (with reference to the position shown in FIGS. 8 and 9) out of the notches 531 in the second frame portion 516, freeing the associated cooking rods 546 from the frame 512 of the cooking grid assembly 510. Instead of individually removing the cooking rods from the notches 531, the cooking grid assembly 510 could, of course, be inverted from the position shown in FIGS. 8 and 9 when the first locking bar 548 and the second locking bar 548 are in unlocked positions thereof to permit the ends of the cooking rods 546 to simultaneously fall free from the notches 531 and fall upon a surface below, such as into a cleaning sink.

An extension member 562 may be outwardly movably mounted to the second frame portion 516 of the frame 512. The illustrated extension member 562 includes an elongate body 564, and a pair of inwardly extending legs 566, although any desired number of legs 566 may be provided. The illustrated body 564 and legs 566 may be substantially cylindrical in shape. Alternatively, the body 564 and legs 566 may have any other desired shape, such as for example, having a rectangular or other polygonal-shaped transverse section. The legs 566 of the extension member 562 may extend through respective apertures in the second frame portion 516 to be slidably mounted within a bore through elongate guide members 539. The guide members 539 may be fixed to each of the first transverse side member 518 and the second transverse side member 519 in any suitable fashion, such as welding, or may be integrally formed with the associated transverse side member. If more than two legs 566 are provided, legs disposed between the legs at either end of the body 664 may extend only through apertures (not shown) in the second frame portion 516, to support adjacent portions of the frame 512. Alternatively, such legs may additionally extend through a guide member (not shown) fixed to the second frame portion 516 with a bore aligned with the associated aperture. The guide members 539 may be provided with a set screw that may be screwed in to engage an associated leg 566 of the extension member 562, releasably fixing the position of the extension member 562 relative to the frame 512. The extension member 562 is movable between a fully retracted or storage position, as shown in FIG. 9, and an extended position, as shown by the phantom line 562′ in FIG. 9.

It will be understood that the extension members 62 may be moved to a plurality of positions intermediate the storage position and the extended position. It will be further understood that the frame 512 and the extension member 562, when in the extended position or one of the intermediate positions, have a combined width and length that cooperate to define a second area of the cooking grid assembly 510, such that the second area is larger than the first area defined by the frame 512 alone. The extension member 562 will allow the cooking grid assembly 510 to be adapted to be supported upon a variety of structures (not shown) having different “front to back” depths between features (not shown) supporting the first frame portion 514 and features (not shown) supporting the second frame portion 516 via the extension member 562.

If desired, the cooking grid assembly 510 may also include a food flange (not shown) similar to the food flanges 68 and 468. However, it should be understood that either the extension member 562 or the food flange might be used without the other.

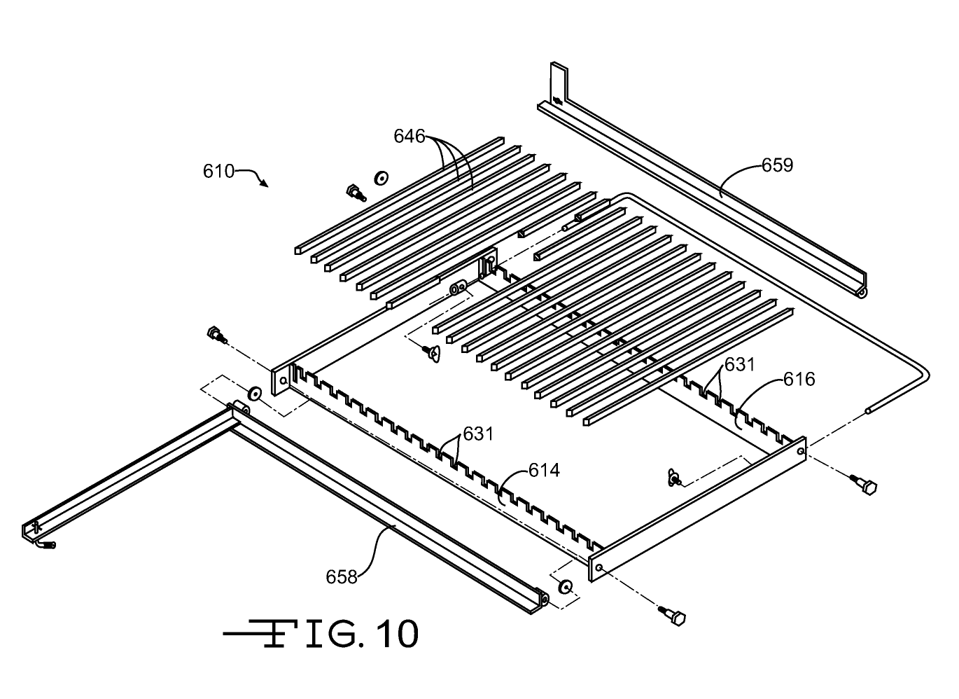

FIG. 10 is an exploded perspective view of a seventh embodiment of a cooking grid assembly, indicated generally at 610. As discussed above with respect to the embodiments illustrated in FIGS. 1, 5, 6, and 8, the notches for retaining cooking rods may have any desired shape. Preferably, the shape of the notch is such that the cooking rod disposed therein is supported transversely and vertically, holding the associated end of the cooking rod up, and preventing substantial side-to-side movement to maintain spacing between adjacent cooking rods. As may easily be determined by comparison of the associated figures, the embodiment of the cooking grid assembly 610 shown in FIG. 10 is substantially identical to the cooking grid assembly 510 shown in FIGS. 8 and 9, except for two differences. The first difference is that the cooking rods 646 of the cooking grid assembly 610 are illustrated as having a rectangular (and, more preferably, a square) transverse cross-section. The only other difference between the cooking grid assembly 610 and the illustrated embodiment of the cooking grid assembly 510 is the shape of notches 631 that may be formed in an upwardly facing edge of the first frame portion 614 and in an upwardly facing edge of the second frame portion 616 are rectangular rather than substantially U-shaped like the notches 531 of the cooking grid assembly 510 described above. Of course, in the discussion above of the cooking grid assembly 510, it was stated that, “the notches 531 may have any other desired shape, such as, for example, a rectangular shape or a V-shape”, and also stated that “The cooking rods 546 may have a circular transverse cross-section, or any other suitable transverse cross-section, including, for example, triangular, square, rectangular, hexagonal, octagonal, or other polygonal shapes.” Thus, the arrangement illustrated in FIG. 10 has already been described in the discussion of the structure of the cooking grid assembly 510.

The rectangular shaped notches 631 are sized so that each of the cooking rods 646 may be easily dropped into an associated pair of the notches 531 (one in the first, or user facing, frame portion 614 and one in the second frame portion 616) with little play. In this manner, both ends of each cooking rod 646 is supported vertically (so that the cooking rod 646 can support food being prepared thereon), and laterally (so as to maintain the regular spacing of the cooking rods 646). The first locking bar 658 and the second locking bar 659 may operate in a manner identical to the locking bars 558 and 559 to secure the cooking rods 646 in the notches 631, and to secure the cooking rods 646 against substantial axial movement. However, each of the cooking rods 646 may be easily removed from the notches 631 when the locking bars 658 and 659 are unlatched and rotated to a release position. As with all the various embodiments shown herein, one purpose for having removable cooking rods 646 is to facilitate cleaning of the cooking rods 646. Instead of having to try to force a cleaning brush in between fixed rods forming a grilling surface, the cooking rods 646 could be placed in a dish washer (for example) for easy automatic cleaning. Alternatively, manual cleaning with a scrubbing pad or other methods of cleaning are also facilitated. Another purpose for removing the cooking rods 646 could be to gain access to the space beneath the cooking grid assembly 610. For example, the cooking grid assembly 610 may be permanently fixed to the grill enclosure (or removably affixed with screws, bolts, etc.). Instead of providing handles (like the handles 20, 320, 420) to lift up and remove the associated cooking grid assembly to gain access to items under the cooking grid assembly, such as a gas burner, or charcoal and ash), if the cooking grid assembly 610 is fixed to the grill enclosure, removing the cooking rods 646 will provide similar access. Of course, the same advantage of the feature of easily removable cooking rods applies equally as well to the other embodiments of cooking grid assemblies described herein.

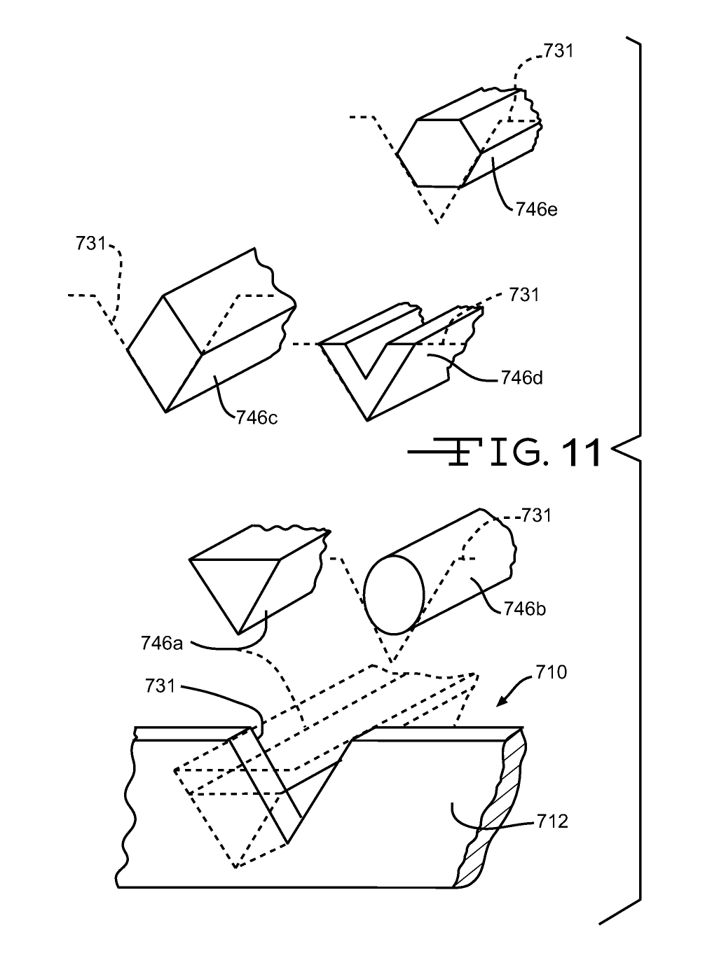

FIG. 11 is a partial exploded perspective view of an alternate embodiment of a cooking grid assembly, indicated generally at 710. The cooking grid assembly 710 includes a frame portion 712, which may be similar to any of the first frame portions or second frame portions described herein. The frame portion 712 is illustrated as having v-shaped notches 731 formed in an upwardly facing edge thereof; a single one of the v-shaped notches 731 being illustrated in FIG. 11. Also illustrated in FIG. 11 are a variety of cooking rods 746a, 746b, 746c, 746d, 746e, and 746f that may be utilized with the frame portion 712, fitting in the v-shaped notches 731. A first illustrated cooking rod is the cooking rod 746a that has a triangular transverse cross-section, and that may fit in the notch 731 as shown in phantom within the notch 731.

A second illustrated cooking rod is the cooking rod 746b with a circular transverse cross-section. The shape of the notch 731 is shown in phantom against the cooking rod 746b to assist in visualizing how the cooking rod 746b might fit within the notch 731. Note that preferably the uppermost portion of the cooking rods 746a through 746f are at the level of the uppermost surface of the frame portion 712, so that the cooking rod will be closely captured by the associated locking bar (not shown), eliminating the possibility of the cooking rod moving significantly relative to the frame 712.

Another illustrated cooking rod is the cooking rod 746c which has a transverse cross-section in the shape of a parallelogram (and specifically, a rhombus). The shape of the notch 731 is shown in phantom against the cooking rod 746c to assist in visualizing how the cooking rod 746c might fit within the notch 731.

The cooking grid assemblies described herein may include a frame; a plurality of straight cooking rods, each cooking rod having a transverse cross-section that is uniform along length of the longitudinal axis of the cooking rod; and a movable locking bar, the locking bar and the frame cooperating to releasably fix the cooking rods in operative position relative to the frame. Preferably, the cooking rods of each of the embodiments described herein are cylindrical or prisms, easily cut from commercially available stock material. However, cooking rods with more unusual transverse cross-sections may be used, such as the cooking rod 746d, which has a V-shaped transverse cross-section. The shape of the notch 731 is shown in phantom against the cooking rod 746d to assist in visualizing how the cooking rod 746d might fit within the notch 731.

Another illustrated cooking rod is the cooking rod 746e which has a transverse cross-section in the shape of a regular hexagon. The shape of the notch 731 is shown in phantom against the cooking rod 746e to assist in visualizing how the cooking rod 746e might fit within the notch 731.

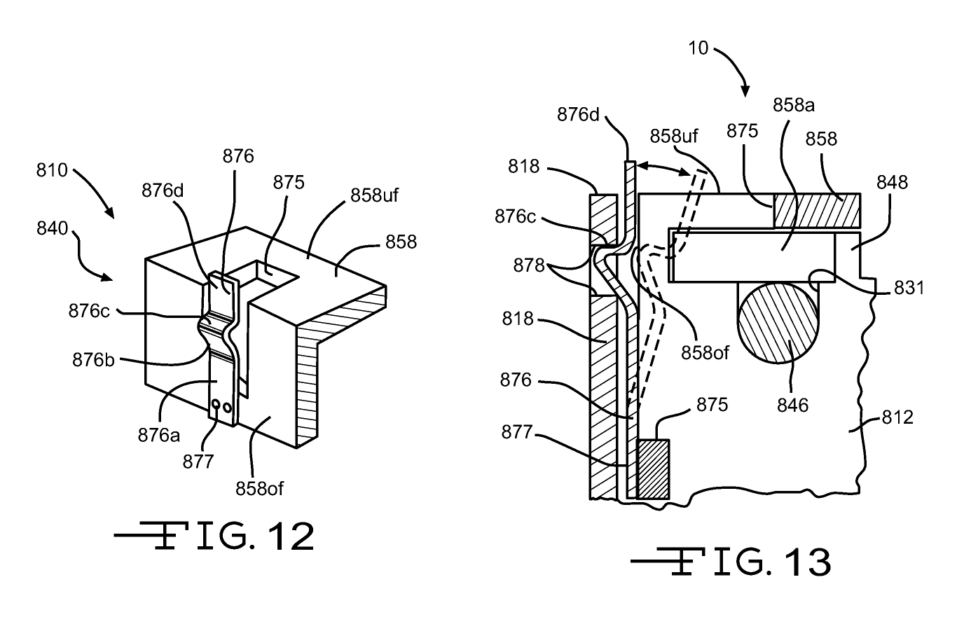

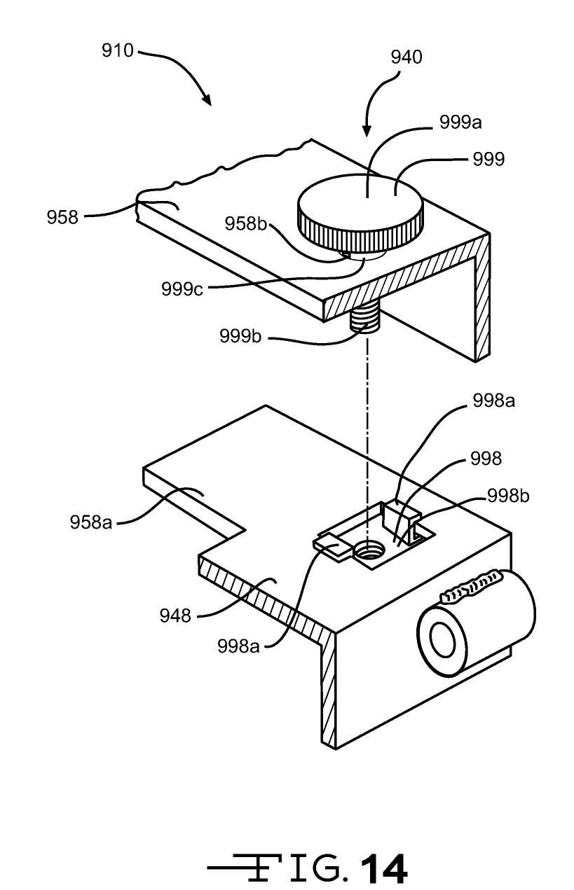

FIG. 12 is a partial perspective view of an alternate embodiment of a cooking grid assembly, indicated generally at 810. The cooking grid assembly 810 is provided with an alternate embodiment of a latching mechanism 840. FIG. 13 is a partial sectional view of the latching mechanism shown in FIG. 12.

The cooking grid assembly 810 may be, for example, similar in structure to the cooking grid assembly 510, except for differences between the latching mechanism 540 described above, and the latching mechanism 840 illustrated in FIGS. 12 and 13. The cooking grid assembly 810 may include a handle 858 for a first locking bar (not shown) similar in structure and function to the handle 558 described above. The handle 858 may have an upper face 858uf and an outer face 858of. Unlike the handle 558, however, an opening 875 may be formed through a portion of the upper face 858uf and the adjacent portion of the outer face 858of the handle 858, as illustrated in FIGS. 12 and 13.

The latching mechanism 840 may include a resilient latch spring 876 fixed to the outer face 858of the handle 858 by any suitable means, such as by spot welding or riveting at a first, fixed end 877. The latch spring 876 is bent to form a first portion 876a extending from the fixed end 877 generally parallel to the outer face 858of. A second portion 876b is inclined outwardly and upwardly (as seen in FIGS. 12 and 13) from the outer face of the handle 858. A third portion 876c extends generally perpendicularly to the outer face 858of the handle 858. A fourth portion 876d is a free end extending generally parallel to the outer face 858of the handle 858, and extending somewhat above the adjacent portions of the upper face 858uf the handle 858.

As seen in FIG. 13, the cooking grid assembly 810 may further include a transverse side member 818 similar to the transverse side member 518, except that a latch receiving aperture 878 may be formed therein, the purpose of which will be described below. The cooking grid assembly 810 may further include a second frame portion 816 having notches 831 formed therein, similar to the second frame portion 516 described above. Cooking rods 846 similar to the cooking rods 546 (or other cooking rods described herein) may be disposed in the notches 831 when installed in the cooking grid assembly. A second locking bar 848 similar to the second locking bar 548 may include a handle 858a similar to the handle 558a.

In FIG. 13 the second locking bar 848 is shown in the locked position thereof, lying over the ends of the cooking rods 846 disposed in the notches 831 in the second frame portion 516, preventing the cooking rods from being lifted out of the notches 831. The first locking bar (not shown) may be moved into the locked position thereof, so that the free end of the handle 858 of the first locking bar overlaps the handle 858a of the second locking bar 848, holding the second locking bar 848 in the locked position thereof, as shown in FIG. 13. As the handle 858 of the first locking bar moves the first locking bar from an unlocked position to the locked position thereof, the second portion 876b of the latch spring 876 will begin to bear against the transverse side member 818, bending the latch spring rightward of the position shown in solid lines in FIG. 13. When the third portion 876c of the latch spring 876 aligns with the latch receiving aperture 878, the spring 878 will spring return to the position shown in solid lines in FIG. 13, with the shoulder formed by the third portion 876c being disposed in the latch receiving aperture 878, preventing upward (as seen in FIG. 13) movement of the handle 858. Thus, the handle 858 is held in place by the latching mechanism 840, holding the first locking bar (not shown) and the second locking bar 848 in the locked positions thereof. To unlatch the latching mechanism 840, the fourth portion 876d of the latch spring 876 is urged rightward (as seen FIG. 13) by a user, away from the transverse side member 818, and into the position shown in dashed lines in FIG. 13, within the opening 875. In this position, the latch spring 876 no longer engages the latch receiving aperture 878 of the transverse side member 818, and the handle 858 is free to be moved to rotate the first locking bar 848 to the unlocked position.

FIG. 14 is a partial perspective view of an alternate embodiment of a cooking grid assembly, indicated generally at 910. The cooking grid assembly 910 may be substantially similar to one of the cooking grid assemblies described above, such as the cooking grid assembly 510. The cooking grid assembly 910 may include a second locking bar 948, which may have a handle 958a, and may also include a handle 958 for a first locking bar (not shown). The cooking grid assembly 910 is provided with an alternate embodiment of a latching mechanism 940. The latching mechanism 940 includes a floating nut plate 998 and a captive screw 999.

The captive screw 999 has a shaft with a head or knob 999a at one end thereof, and a threaded end portion 999b at the other end thereof. The threaded end portion 999b can be screwed through a threaded bore 958tb through the handle 958. Between the threaded end portion 999b of the shaft and the knob 999a at the other end of the captive screw 999, the shaft has a smooth reduced diameter section 999c where the shaft of the captive screw 999 passes through the threaded bore 958tb in the handle 958 when the captive screw 999 is installed for use. The smooth, reduced diameter of this section 999c of the shaft allows the installed captive screw 999 to rotate freely relative to the handle 958. The only non-destructive way to remove the captive screw 999 may be to urge the captive screw 999 in a direction to cause the threaded end portion 999b of the shaft to bear against the handle 958 while rotating the captive screw 999 in a direction to cause the male threads of the screw to engage the female threads of the threaded bore 958tb in the handle 958, allowing the captive screw 999 to be unscrewed from the handle 958.

Floating nut plates are well known devices which may include a base plate with an opening (not shown) and supporting a nut or similar fastener element, which is captured on the base by a retainer, canopy or cage element, but allowed to float laterally within the retainer. The base plate is permanently or removably fixed to the component on which the nut plate is to be installed in any suitable manner. In the illustrated example, the nut plate 998 may include features such as spring arms 998a that engage the edges of an opening through the component in which the nut plate 998 is installed, which may be the second locking bar 948. The spring arms 998a may be bent inwardly to remove the nut plate 998. The nut plate 998 includes a captured nut 998b that receives the threaded end portion 999b of the captive screw 999, which is threaded into the nut 999b when the first and second locking bars are in the locked positions thereof, to latch the handle 958 of the first locking bar in the locked position, and latching the second locking bar 948 in the locked position. The nut 998b may make slight lateral movements to align itself with the captive screw 999. To unlatch the locking bar handle 958, the captive screw 999 is rotated until the captive screw 999 is unthreaded from the captive nut 999b, allowing the locking handle 958 to be moved, with the captive screw 999 still retained within the threaded bore 958tb through the handle 958. With the locking handle 958 moved out of the way, the handle 958a of the second locking bar 958 may be used to move the locking bar 958 to an unlocked position thereof.

While the embodiments of frames described above may refer to a first frame portion as being a user facing frame portion, such description should not be interpreted as a limitation upon the use of the cooking grid assemblies described above; a user may use any of these embodiments of cooking grid assemblies from any suitable position about the periphery of the cooking grid assembly. Furthermore, certain features are described as being associated with particular frame portions, but it will be appreciated that many of these features may be relocated to other frame portions without substantial, or any, diminishment of function. For example, the extension members described above are described as being associated with a second frame portion. However, extension members may instead, or additionally, be mounted on the first frame portions and the transverse side members. As another example, handles may be mounted on the first and second frame portions. Furthermore, it should be appreciated that the latching mechanism 940 (and the latching mechanism 840) have been described in the embodiment of a cooking grid assembly generally similar to the cooking grid assembly 510, in that two locking bars with handles are described. However, the latching mechanisms 840 and 940 may be adapted for operation with any of the embodiments above by simple repositioning of the components of the latching mechanism. For example the latching mechanism 940 could be adapted to the cooking grid assembly 10 illustrated in FIGS. 1 and 2 by removing the components of the latching mechanism 40, installing a captive screw in the inwardly extending portion of the elongate body 50 of the locking bar 48, and by fixing a floating nut plate between the upwardly extending first tab 26 and the upwardly extending portion 22 of the first frame portion 14 in a position to be engaged by the floating screw when the locking bar 48 is in the locked position thereof.

The principle and mode of operation of the cooking grid assembly have been described in its various embodiments. However, it should be noted that the cooking grid assembly may be practiced otherwise than as specifically illustrated and described without departing from its scope.

What is claimed is:

1. A cooking grid assembly comprising:
a frame including first and second frame portions, said first and second frame portions each having one of a plurality of notches and a plurality of holes formed therein;
a plurality of rods having first and second ends, said first end of each rod being disposed in one of said notches and holes of said first frame portion, and said second end of each rod being disposed in one of said notches and holes of said second frame portion;
a locking bar removably attached to one of said first and second frame portions, said locking bar being movable between a closed position wherein said rods are retained in the one of said notches and holes, and an open position wherein said rods may be inserted and removed from the one of said notches and holes; and
an extension member fixed to and outwardly movable relative to said frame so as to provide support to said frame, said extension member being movable between a storage position, an extended position, and a plurality of positions intermediate of said storage position and said extended position.

2. The cooking grid assembly according to claim 1, wherein said notches and said holes are disposed axially parallel at regular intervals along a length of said first and second frame members.

3. The cooking grid assembly according to claim 1, wherein said frame defines a first area.

4. The cooking grid assembly according to claim 3, wherein when said extension member is in one of said intermediate positions and said extended position, said frame and said extension member define a second area larger than the first area.

5. The cooking grid assembly according to claim 1, wherein said frame further includes a pair of transverse side members connecting said first and second frame portions.

6. The cooking grid assembly according to claim 1, wherein said second frame portion has a substantially U-shaped transverse section, said second frame portion defining a first wall portion and a substantially parallel second wall portion, said first wall portion having one of a plurality of notches and a plurality of holes formed therein, said one of a plurality of notches and a plurality of holes being linearly disposed and axially parallel at regular intervals, such that said plurality of notches and holes of said first wall portion are axially aligned with said plurality of notches and holes of said first frame portion.

7. The cooking grid assembly according to claim 1, wherein said locking bar is pivotally attached to said first frame portion, said locking bar being pivotal between said closed position and said open position, said locking bar further having a structure allowing said locking bar to be removable from the one of said first and second frame portions such that no portion of said cooking grid assembly is permanently deformed during the removal of said locking bar.

8. The cooking grid assembly according to claim 1, wherein said extension member is slidably mounted and outwardly movable relative to said second frame portion.

9. The cooking grid assembly according to claim 1, wherein said frame is substantially rectangular in shape.

10. The cooking grid assembly according to claim 1, wherein said frame is substantially circular in shape.

11. The cooking grid assembly according to claim 1, wherein each said rod includes an axis, said axes of said rods cooperating to define a plane substantially containing said rods, said cooking grid assembly further including a food flange extending perpendicularly to said plane containing said rods and extending upwardly from said rods, said food flange being slidably mounted on at least one rod.

12. A cooking grid assembly comprising:
a frame including first and second frame portions, said first and second frame portions each having one of a plurality of notches and a plurality of holes formed therein;
a plurality of rods having first and second ends, said first end of each rod being disposed in one of said notches and holes of said first frame portion, and said second end of each rod being disposed in one of said notches and holes of said second frame portion; and
a locking bar pivotally attached to each of said first and second frame portions, each said locking bar being pivotal between a closed position wherein said rods are retained in the one of said notches and holes, and an open position wherein said rods may be inserted and removed from the one of said notches and holes, said locking bar further having a structure allowing said locking bar to be removable from said first and second frame portions such that no portion of said cooking grid assembly is permanently deformed during the removal of said locking bar.

13. The cooking grid assembly according to claim 12, further including an extension member, said extension member fixed to and outwardly movable relative to said frame so as to provide support to said frame, such that said extension member is movable between a storage position, an extended position, and a plurality of positions intermediate of said storage position and said extended position.

14. The cooking grid assembly according to claim 12, wherein said closed position defines a latched position and said open position defines an unlatched position.

15. The cooking grid assembly according to claim 14, wherein said first frame portion includes a hole formed therein, said hole defining a radially outwardly extending pin notch, wherein a detent groove is formed on a downwardly facing surface of said first frame portion, and wherein said latching mechanism includes:
an elongate body having a first end, a second end, and a pin axis, said second end defining a handle portion;
at least one locking pin extending radially outward of said body;
a spring flange extending radially outward of said body;
a spring disposed between said locking pin and said spring flange; and
at least one retaining pin extending radially outward of said body between said spring flange and said handle portion;
wherein said body is slidably and rotatably mounted in said locking bar, such that a portion of said locking bar is disposed between said spring flange and said retaining pin; and
wherein in said latched position, said body of said latching mechanism is disposed in said hole of said first frame portion such that said spring urges said locking pin into said detent groove.

16. The cooking grid assembly according to claim 12, wherein each said rod includes an axis, said axes of said rods cooperating to define a plane substantially containing said rods, said cooking grid assembly further including a food flange extending perpendicularly to said plane containing said rods and extending upwardly from said rods, said food flange being slidably mounted on at least one rod.

17. The cooking grid assembly according to claim 12, wherein said frame is substantially rectangular in shape.

18. The cooking grid assembly according to claim 12, wherein said frame is substantially circular in shape.

19. A cooking grid assembly comprising:
a frame including first and second frame portions, said first and second frame portions each having one of a plurality of notches and a plurality of holes formed therein;
a plurality of rods having first and second ends, said first end of each rod being disposed in one of said notches and holes of said first frame portion, and said second end of each rod being disposed in one of said notches and holes of said second frame portion; and
a locking bar removably attached to said first frame portion, said locking bar being movable between a closed position wherein said rods are retained in the one of said notches and holes, and an open position wherein said rods may be inserted and removed from the one of said notches and holes;
wherein said frame, said plurality of rods, and said locking bar define a substantially horizontal surface upon which food to be cooked is supported.

20. The cooking grid assembly according to claim 19, wherein said locking bar is pivotally attached to said first frame portion, said locking bar being pivotal between said closed position and said open position, said locking bar further being removable from said first frame portion such that no portion of said cooking grid assembly is permanently deformed during the removal of said locking bar.

21. A cooking grid assembly, comprising:
a frame;
a plurality of straight cooking rods, each cooking rod having a transverse cross-section that is uniform along length of the longitudinal axis of the cooking rod; and
a movable locking bar, the locking bar and the frame cooperating to releasably fix the cooking rods in operative position relative to the frame.
